(19) United States
(12) Patent Application Publication
(10) Pub. No.: US 2010/0161970 A1
(43) Pub. Date: Jun. 24, 2010

(54) USER TERMINAL AND METHOD OF MANAGING USER INFORMATION

(75) Inventors: Yun Kyung LEE, Daejeon (KR); Byung Ho CHUNG, Daejeon (KR); Jeong Nyeo KIM, Daejeon (KR); Seung Wan HAN, Gwangju (KR); Sok Joon LEE, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/582,097

(22) Filed: Oct. 20, 2009

(30) Foreign Application Priority Data
Dec. 22, 2008 (KR) 10-2008-0131711

(51) Int. Cl. H04L 9/00; G06F 17/30

(52) U.S. Cl. 713/156; 707/E17.008; 707/E17.032

(57) ABSTRACT

A user terminal and a method of managing user information are provided. The method includes issuing a request for issuance of a certificate for a user to a certification authority; generating a document including at least part of user information using a certificate issued by the certification authority; and issuing a subscription request to a desired web service provider by providing the document including the at least part of the user information to the desired web service provider. Therefore, it is possible to strengthen the user's right to self-determination and control over the exposure and use of his or her personal information. In addition, it is possible to improve the reliability of user information provided to each website by the user.

### CROSS-REFERENCE TO RELATED APPLICATION

This application claims the benefit of Korean Application No. 10-2008-0131711, filed on Dec. 22, 2008 in the Korean Intellectual Property Office, the disclosure of which is incorporated herein by reference.

### BACKGROUND OF THE INVENTION

1. Field of the Invention

The present invention relates to a user terminal and a method of managing user information, and more particularly, to a user terminal and a method of managing user information, in which user information can be safely and efficiently managed by strengthening a user's right to self-determination and control over the exposure and use of his or her personal information.

The present invention is based on research (Project Management No.: 2008-S-036-01, Project Title: Development of Anonymity-based Knowledge Information Protection Technology) conducted as part of Information Technology (IT) Growth Power Technology Development Project launched by Ministry of Information and Communication and Institute for Information Technology Advancement (IITA).

2. Description of the Related Art

Due to recent developments in web services, many people are now being provided with various web services through the internet. In order to use a web service provided by a website, users may need to provide their user information to the website and thus to subscribe for the website. User information generally includes the name, social security number and identifier (ID) of each user. The exposure of user information may cause serious damage to users.

An increasing number of incidents of hacking have been reported even from major portal websites or electronic-commerce (e-commerce) websites. Customers' personal details may be lost, stolen or exposed not only due to various hacking attempts or but also due to web service providers' failure to properly handle such valuable information. For example, in order to receive information or assistance from a website during the use of a web service provided by the website, users are generally required to have their personal information viewed by the website's customer services personnel without any approval, thereby increasing the probability of user information being exposed.

Once user information is exposed, it is almost impossible to retrieve the user information. Thus, the exposure of user information may cause serious damage to users. In addition, with a heightened awareness of the management of private information, the demand for strengthening users' right to self-determination and control over the exposure and use of their personal information has increased considerably.

### SUMMARY OF THE INVENTION

The present invention provides a user terminal and a method of managing user information, in which user information can be safely and efficiently managed by strengthening a user's right to self-determination and control over the exposure and use of his or her personal information.

According to an aspect of the present invention, there is provided a method of managing user information, the method including issuing a request for issuance of a certificate for a user to a certification authority; generating a document including at least part of user information using a certificate issued by the certification authority; and issuing a subscription request to a desired web service provider by providing the document including the at least part of the user information to the desired web service provider.

According to another aspect of the present invention, there is provided a user terminal including an authentication request unit issuing a request for issuance of a certificate for a user to a certification authority; a document generation unit generating a document including at least part of user information using a certificate issued by the certification authority; and a user information management program issuing a subscription request to a desired web service provider by providing the document including the at least part of the user information to the desired web service provider.

According to the present invention, it is possible to strengthen a user's right to self-determination and control over the exposure and use of his or her personal information. In addition, it is possible to improve the reliability of user information provided to each website by a user.

### BRIEF DESCRIPTION OF THE DRAWINGS

apparent by describing in detail preferred embodiments thereof with reference to the attached drawings in which:

FIG. 1 illustrates a block diagram of a user information management system including a user terminal having a user information management function, according to an exemplary embodiment of the present invention;

FIG. 2 illustrates a message sequence chart showing how the user terminal shown in FIG. 1 can subscribe for a web service provider using a certificate; and

FIG. 3 illustrates a flowchart showing how the user terminal shown in FIG. 1 can log on to the website of a web service provider.

### DETAILED DESCRIPTION OF THE EMBODIMENTS

The present invention will hereinafter be described in detail with reference to the accompanying drawings in which exemplary embodiments of the invention are shown.

A user terminal and a method of managing user information according to exemplary embodiments of the present invention can allow a user to generate a document based on a certificate issued using user information and thus to manage the user information using the document.

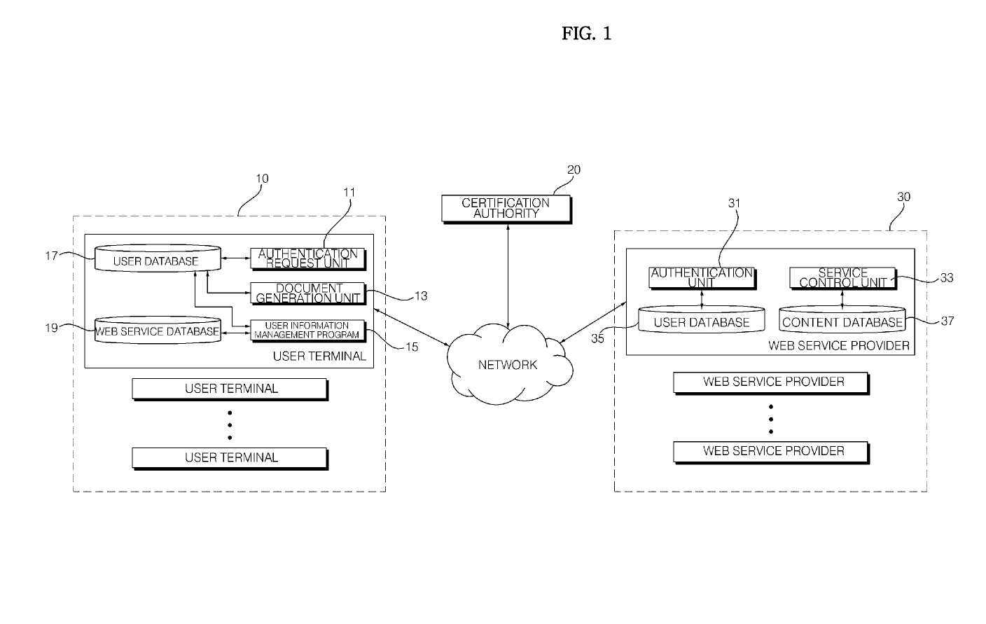

FIG. 1 illustrates a block diagram of a user information management system including a user terminal having a user information management function, according to an exemplary embodiment of the present invention. Referring to FIG. 1, the user information management system may include at least one user terminal 10, a certification authority 20 and one or more web service providers 30.

The certification authority 20 may issue a certificate to a user of the user terminal 10 at the request of the user. More specifically, in order to receive a certificate from the anonymous certification authority 20, the user may need to be provided with a personal code (such as an ID and a password) through face-to-face authentication by a reliable organization such as a bank or a securities company. The reliable organization may provide the user information of the user and the same personal code as that provided to the user to the certification authority 20. Then, the certification authority 20 may generate a certificate and provide the certificate to the user by comparing a personal code and user information provided by the user with the personal code and the user information provided by the reliable organization. The certificate generated by the certification authority 20 may include the name and identifier (ID) of the user, the expiration date of the corresponding certificate and the name of the certification authority 20.

The user terminal 10 may manage the user information of the user using the certificate issued by the certification authority 20. The user terminal 10 may include a user information database 17, a web service database 19, an authentication request unit 11, a document generation unit 13 and a user information management program 15.

The user information database 17 may store the user information of the user. If necessary, the user information database 17 may also store user terminal information regarding the user terminal 10.

The web service database 19 may store web service provider information regarding one or more web service providers 30 for which the user has subscribed. The web service provider information may include a website list including websites of the web service providers 30 for which the user has subscribed, the addresses of the websites, access information necessary for accessing the websites, and log information generated as a result of the use of the websites by the user.

The access information may include an ID and a password. The log information may include the names of a number of websites used by the user, the addresses of the websites, the dates on which the websites are accessed by the user, a statement regarding the purchase of items or contents from the websites by the user, a statement regarding the paying of bills by the user, a statement regarding the change of user information by the user. The user information may decide what information should be stored as the log information and may determine how long the log information should be stored for. The user may set different storage durations for different items of the log information.

The authentication request unit 11 may transmit the user's personal code provided by such a reliable organization as a bank to the certification authority 20 and may thus issue a request for the issuance of a certificate to the certification authority 20. More specifically, the authentication request unit 11 may transmit the user information present in the user information database 17 and a personal code input by the user to the anonymous certification authority 20. For this, the user information present in the user information database 17 and the personal code input by the user may be encrypted with a key that is only known to the user.

The document generation unit 13 may generate a document based on the certificate issued by the anonymous certification authority 20. The document generated by the document generation unit 13 may include the certificate issued by the anonymous certification authority 20 and access information necessary for subscribing for and logging on to the website of whichever of the web service providers 30 is desired by the user. If the web service providers 30 require different access information, the document generation unit 13 may generate different documents for the web service providers 30. The access information included in the document generated by the document generation unit 13 may include the name, address, phone number, age and sex of the user. The document generation unit 13 may generate a document including the name of the user, a document including the address of the user, a document including the phone number of the user, a document including the age of the user, a document including the sex of the user, or a document including at least two of the name, address, phone number, age and sex of the user.

The document generation unit 13 may generate a document in advance and may store the generated document in the user information database 17. Alternatively, the document generation unit 13 may generate a document whenever necessary.

When the user chooses to subscribe for the website of a desired web service provider 30 chosen from the web service providers 30, the user information management program 15 may withdraw a document including access information corresponding to the desired web service provider 30 from the user information database 17 and may transmit the withdrawn document to the desired web service provider 30. If none of the documents present in the user information database 17 include the access information corresponding to the web service provider 30, the user information management program 15 may control the document generation unit 13 to generate a new document including the access information corresponding to the desired web service provider 30.

In addition, if the user drives a web browser or chooses an icon in order to access the internet, the user information management program 15 may withdraw a web service provider list including a number of web service providers 30 for which the user has subscribed from the web service database 19 and may display the withdrawn web service provider list. If the user chooses one of the web service providers 30 included in the web service provider list displayed by the user information management program 15, the user information management program 15 may withdraw an ID and a password corresponding to the website of the chosen web service provider 30 from the web service database 19 and may provide the withdrawn ID and password to the document generation unit 13. Thereafter, if the document generation unit 13 generates a document including the ID and password provided by the user information management program 15, the user information management program 15 may provide the document to the chosen web service provider 30 so that the user can log on to the website of the chosen web service provider 30. In short, the user information management program 15 may enable the user to automatically log on to the website of the chosen web service provider 30.

If the user wishes to access the website of the chosen web service provider 30, rather than to log on to the website of the chosen web service provider 30, the user information management program 15 may allow the user to simply access the website of the chosen web service provider 30. For this, the user information management program 15 may provide a button for choosing whether to log on to or simply access the website of the chosen web service provider 30 along with the web service provider list. In this case, login information necessary for logging on to the website of the chosen web service provider 30 may be transmitted to the website of the chosen web service provider 30 at any time upon the request of the user.

The user information management program 15 may withdraw the user information present in the user information database 17 and may display the withdrawn user information, thereby allowing the user to update his or her user information. Once the user updates his or her user information, the user information management program 15 may store the updated user information in the user information database 17. In this case, if the user chooses one of the web service providers 30 included in the web service provider list, the user information management program 15 may transmit the updated user information to the document generation unit 13 and may control the document generation unit 13 to generate a new document based on the updated user information. Thereafter, the user information management program 15 may transmit the new document to the chosen web service provider 30.

A document provided by the user terminal 10 must be encrypted in order to protect the user information of the user and must be able to be decrypted only by whichever of the web service providers 30 is provided with the document.

Each of the web service providers 30 may run a website that provides various services to the user. Each of the web service providers 30 may include an authentication unit 31, a content database 37, a user database 35 and a service control unit 33.

The authentication unit 31 may issue a request for submittal of a document to the user who wishes to subscribe for or log on to the website of a corresponding web service provider 30 and may decide whether to provide a service to the user based on a certificate included in a document provided by the user. The authentication unit 31 may also issue a request for submittal of access information necessary for subscribing for and/or logging on to the website of the corresponding web service provider 30 to the user.

The authentication unit 31 may authenticate the certificate included in the document provided by the user based on the ID, password, and expiration date of the corresponding certificate. If the certificate included in the document provided by the user is determined to be valid, the authentication unit 31 may transmit a message to the service control unit 33, indicating that the certificate included in the document provided by the user has been successfully authenticated.

The content database 37 may store various contents that can be provided to the user by the corresponding web service provider 30. Examples of the various contents include broadcast programs, moving images, and internet protocol television (IPTV) programs.

The user database 35 may store access information included in the document provided by the user and the ID of the certificate included in the document provided by the user. The user database 35 may also include log information generated as a result of the use of the website of the corresponding web service provider 30 by the user such as a list of items added to the user's Shopping Cart, the user's purchase history and a list of questions posted in the Q&A section by the user.

The service control unit 33 may withdraw a content desired by the user from the content database 37 and may provide the withdrawn content to the user terminal 10. The service control unit 33 may store the user information of the user and the log information in the user database 35.

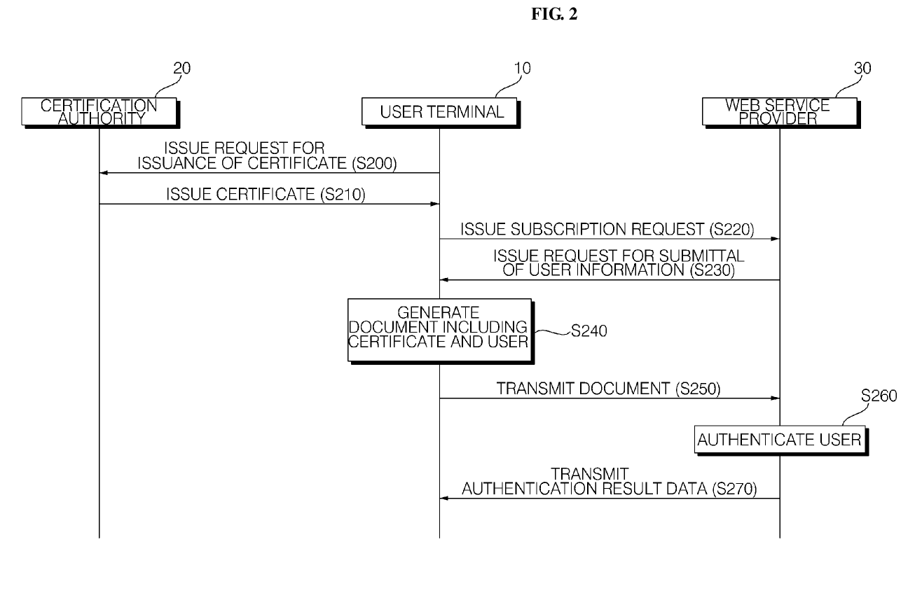

It will hereinafter be described in detail how the user terminal 10 can subscribe for each of the web service providers 30 using a certificate with reference to FIG. 2.

Referring to FIG. 2, the authentication request unit 11 of the user terminal 10 may transmit user information and a personal code of the user to the certification authority 20 and may issue a request for the issuance of a certificate to the certification authority 20 (S200). The certification authority 20 may issue a certificate to the user terminal 10 by comparing a personal code and user information provided by such an organization as a bank with the user information and the personal code provided by the user terminal 10 (S210).

If the user terminal 10 issues a subscription request to a desired web service provider 30 chosen from the web service providers 30 (S220), the desired web service provider 30 may issue a request for submittal of information necessary for subscribing for the web service provider 30 to the user terminal 10 (S230). The document generation unit 13 may generate a document including a certificate withdrawn from the user information database 17 (S240), and may provide the generated document to the desired web service provider 30 (S250). The authentication unit 31 of the desired web service provider 30 may authenticate the user using the certificate included in the document generation unit 13 (S260). Once the user is successfully authenticated, access information necessary for accessing the website of the desired web service provider 30 may be stored in the user database 35, the user's subscription for the desired web service provider 30 may be complete, and authentication result data may be transmitted to the user terminal 10 (S270).

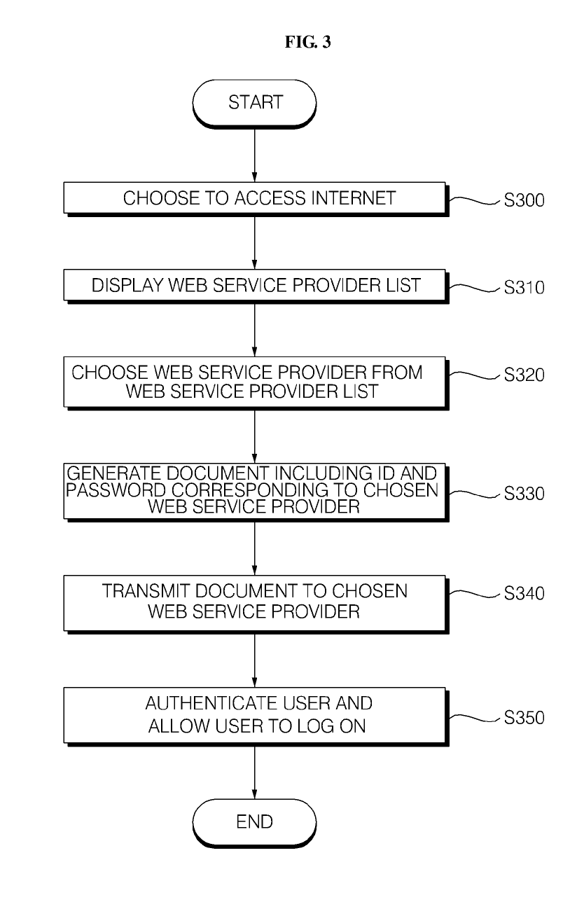

It will hereinafter be described in detail how the user terminal 10 logs on to the website of the desired web service provider 30 with reference to FIG. 3.

Referring to FIG. 3, if the user 10 chooses to log on to the website of a desired web service provider 30 chosen from the web service providers 30 (S300), the user information management program 15 may withdraw a web service provider list, including a number of web service providers 30 for which the user has subscribed, from the web service database 19 and may display the withdrawn web service provider list (S310). If the user chooses the desired web service provider 30 from the web service provider list displayed by the user information management program 15 (S320), the user information management program 15 may withdrawn an ID and a password corresponding to the desired web service provider 30 and may provide the withdrawn ID and password to the document generation unit 13. Thereafter, the document generation unit 13 may generate a document including the ID and password provided by the user information management program 15 (S330). Thereafter, the user information management program 15 may provide the document generated by the document generation unit 13 to the desired web service provider 30 (S340).

The authentication unit 31 of the desired web service provider 30 may authenticate a certificate included in the document provided by the user information management program 15, and may allow the user to log on to the website of the desired web service provider 30 with the ID and password included in the document provided by the user information management program 15 (S350).

The user information management program 15 may store log information generated during the use of the desired web service provider 30 by the user in the web service database 19.

In short, the user terminal 10 may manage the user information of the user. Therefore, it is possible to strengthen the user's right to self-determination and control over the exposure and use of his or her personal information. In addition, since the user information management program 15 enables the user to automatically subscribe for and log on to each of the web service providers 30, it is possible to improve user convenience. Moreover, it is possible to improve the reliability of user information provided to each website by the user by providing a certificate along with the user information upon the request of a corresponding web service provider 30.

The present invention can be applied to the improvement of the security of a network and personal information.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing user information, the method comprising:
issuing a request for issuance of a certificate for a user to a certification authority;
generating a document including at least part of user information using a certificate issued by the certification authority; and
issuing a subscription request to a desired web service provider by providing the document including the at least part of the user information to the desired web service provider.

2. The method of claim 1, further comprising:
displaying a web service provider list including a number of web service providers for which the user has subscribed;
if one of the web service providers is chosen from the web service provider list, withdrawing information necessary for logging on to a website of the chosen web service provider;
generating a document including the withdrawn information using the certificate issued by the certification authority; and
allowing the user to subscriber for the chosen web service provider by transmitting the document including the withdrawn information.

3. The method of claim 1, further comprising:
receiving new user information;
generating a new document including the new user information using the certificate issued by the certification authority; and
allowing the desired web service provider to update the existing user information by transmitting the new document to the desired web service provider.

4. The method of claim 1, further comprising storing log information generated during the use of the website of the desired web service provider by the user in a database.

5. A user terminal comprising:
an authentication request unit issuing a request for issuance of a certificate for a user to a certification authority;
a document generation unit generating a document including at least part of user information using a certificate issued by the certification authority; and
a user information management program issuing a subscription request to a desired web service provider by providing the document including the at least part of the user information to the desired web service provider.

6. The user terminal of claim 5, wherein the document generation unit generates a document including information necessary for subscribing for the desired web service provider.

7. The user terminal of claim 5, wherein the user information management program displays a web service provider list including a number of web service providers for which the user has subscribed, withdraws information necessary for logging on to whichever of the web service providers included in the web service provider list is chosen by the user, provides the withdrawn information to the document generation unit, controls the document generation unit to generate a document including the withdrawn information, and issues a login request to the chosen web service provider by transmitting the document including the withdrawn information.

8. The user terminal of claim 5, wherein, if new user information is received, the user information management program provides the new user information to the document generation unit, controls the document generation unit to generate a new document including the new user information using the certificate issued by the certification authority, and allows the desired web service provider to update the existing user information by transmitting the new document to the desired web service provider.

9. The user terminal of claim 5, wherein the user information management program stores log information generated during the use of the website of the desired web service provider by the user in a database.
